(19) United States
(12) Patent Application Publication
(10) Pub. No.: US 2022/0112116 A1
(43) Pub. Date: Apr. 14, 2022

(54) GLASS SHEET PROCESSING APPARATUS AND METHOD

(71) Applicant: CORNING INCORPORATED, CORNING, NY (US)

(72) Inventors: James William Brown, Painted Post, NY (US); Shin-I Huang, Beitun Dist, Taichung City (TW); Tzu-Yen Kao, Situn District, Taichung City (TW)

(21) Appl. No.: 17/277,840

(22) PCT Filed: Sep. 12, 2019
(86) PCT No.: PCT/US2019/050729

§ 371 Date: Mar. 19, 2021

Related U.S. Application Data
(60) Provisional application No. 62/733,129, filed on Sep. 19, 2018.

(51) Int. Cl. C03B 35/20; C03B 35/16

(52) U.S. Cl. CPC C03B 35/205; C03B 2225/02; C03B 35/164

(57) ABSTRACT

Apparatus and methods for processing a glass sheet that includes a threading tool movable between an open position and a closed position, a glass sensor, a gripping device sensor and a controller in communication with the glass sensor and the gripping device sensor, and configured to coordinate and control movement of the threading tool between the open position and the closed position based on the detected presence of the glass sheet and the detected presence of the gripping device. A control system is also provided.

### CROSS-REFERENCE TO RELATED APPLICATIONS

This application claims the benefit of priority of U.S. Provisional Application Ser. No. 62/733,129 file on Sep. 19, 2018 the contents of which are relied upon and incorporated herein by reference in their entirety as if fully set for below.

### BACKGROUND

Glass sheets are commonly fabricated from glass ribbons formed by a variety of ribbon forming processes including, float, slot draw, down-draw, fusion down-draw, up-draw, or any other forming processes. The glass ribbon from any of these processes may then be subsequently processed to remove edge beads and divided by mechanical scoring and breaking to provide one or more glass sheets suitable for further processing into a desired application, including but not limited to, a display application. For example, the one or more glass sheets can be used in a variety of display applications, including liquid crystal displays (LCDs), electrophoretic displays (EPD), organic light emitting diode displays (OLEDs), plasma display panels (PDPs), or the like. Glass sheets may be transported from one location to another. The glass sheets may be transported with a conventional support frame designed to secure a stack of glass sheets in place. Moreover, interleaf material can be placed between each adjacent glass sheet to help prevent contact between, and therefore preserve, the pristine surfaces of the glass sheets.

Glass sheets processed after separation from an as-formed ribbon can attract undesired glass chips and particles formed during mechanical scoring and breaking processes used for ribbon cutoff and to remove the edge beads. These glass chips and particles can become bonded to the glass surface causing the entire sheet to be unacceptable for many display applications. Glass chips and particles, commonly referred to as adhered glass, create defects in display devices. One method used to remove adhered glass involves cleaning the glass surface before the adhered glass actually bonds.

Cleaning processes typically rely on the glass sheet being presented to cleaning tools such as high-pressure nozzles, brushes and the like in a fixed plane so that the applied force is consistent during cleaning. Maintaining the glass in a fixed plane is also important during drying, since sheet glass drying relies on water removal through force of the air from an air knife directed across the glass major surface. Changes in the elevation gap between the air knife and the glass major surface being dried prevent consistent drying across the major surface. Also, localized forces due to high pressure cleaning or drying of a shaped sheet can easily create force imbalances between the A and B sides (front major surface and back major surface) as well as left to right differences. These force differences can cause the glass sheet to become unstable, and vibration during cleaning potentially causes the sheet to contact the cleaning and/or drying apparatus.

Accordingly, it would be desirable to provide apparatus and methods that position and convey a glass sheet into a glass sheet processing station, for example, a cleaning station or a drying station, with sufficient precision to align the glass to a predefined glass plane which would be in plane with a motion system moving the glass and would allow positioning of the cleaning tools within a fixed distance offset from the glass major surface. It would also be desirable to secure the glass sheet during processing steps involving the application of high-pressure liquid or gas, such as a washing or drying operation, to prevent undesirable vibration.

### SUMMARY

A first aspect of the present disclosure provides an apparatus for processing a glass sheet that includes a pair of major surfaces defining a thickness therebetween. In certain embodiments, the apparatus includes a threading tool that includes a first upper guide arm secured to a first upper extension device, a second upper guide arm secured to a second upper extension device, one or more of the first upper guide arm or the second upper guide arm movable between an open position in which the first upper guide arm and the second upper guide arm are separated by a separation distance S greater than the thickness of the glass sheet and a closed position in which the first upper guide arm and second upper guide arm each guide an opposing major surface of the glass sheet at an edge of the glass sheet. The apparatus further includes a gripping device to grip a top edge portion of the glass sheet, a glass sensor positioned to detect a presence of a leading edge of the glass sheet as the glass sheet approaches the glass sensor from an upstream process direction, a gripping device sensor positioned to detect a presence of the gripping device as the gripping device approaches the gripping device sensor from the upstream process direction, and a controller configured to coordinate and control movement of one or more of the first upper guide arm or the second upper guide arm between the open position and the closed position based on the detected presence of the glass sheet and the detected presence of the gripping device. In certain embodiments, one or more of the glass sensor or the gripping device sensor includes a photoelectric sensor or an ultrasonic sensor.

In certain embodiments, the apparatus includes a carrier to transport the glass sheet, and in further embodiments, further includes a carrier sensor positioned to detect a presence of the carrier as the carrier approaches the carrier sensor from the upstream process direction. In certain embodiments, the gripping device is supported by the carrier. In certain embodiments, the carrier includes a metallic component and the carrier sensor comprises a proximity sensor adapted to ascertain proximity of the metallic component. In certain embodiments, the glass sheet includes a length, and an aspect ratio defined as the length divided by the thickness is greater than about 2000.

The apparatus, in certain embodiments, can further include a lower threading tool that includes a first lower guide arm secured to a first lower extension device and a second lower guide arm secured to a second lower extension device, one or more of the first lower guide arm or the second lower guide arm movable between an open position in which the first lower guide arm and the second lower guide arm are separated by a separation distance D greater than the thickness of the glass sheet and a closed position in which the first lower guide arm and the second lower guide arm each guide an opposing major surface of the glass sheet at a bottom edge portion of the glass sheet. The separation distance S can be, for example, from about 1.0 mm to about 50 mm.

In certain embodiments, the one or more gripping devices are located from about 0.1 mm to about 15 mm below the top edge portion of the glass sheet, and in the closed position, the first upper guide arm and the second upper guide arm are configured to guide the glass sheet from 0.1 mm to about 15 mm below the top edge portion of the glass sheet.

Another aspect of the present disclosure provides a method of processing a glass sheet comprising a pair of major surfaces defining a thickness therebetween, a leading edge, and a trailing edge. In certain embodiments, the method includes conveying a glass sheet in a conveyance direction so that the leading edge is conveyed through a glass sheet processing station followed by the trailing edge, the glass sheet supported from a top edge portion of the glass sheet by a gripping device, detecting a presence of the leading edge of the glass sheet with a glass sensor as the glass sheet moves in the conveyance direction from an upstream location, closing a pair of guide arms on the glass sheet after the leading edge of the glass sheet has been detected by the glass sensor such that the pair of guide arms each guide the glass sheet, detecting a presence of the gripping device with a gripping device sensor, opening the pair of guide arms to allow the gripping device to pass between the pair of guide arms, and closing the pair of guide arms after the gripping device has been conveyed past the gripping device sensor.

In certain embodiments, the method further includes drying the glass sheet after the gripping device has been conveyed past the gripping device sensor and the pair of guide arms are closed. For example, drying the glass sheet can include applying a gas to the glass sheet to dry the glass sheet. In certain embodiments, the method further includes transporting the glass sheet from the upstream location with a carrier and detecting a presence of the carrier with a carrier sensor. In certain embodiments, the carrier is transported from the upstream location with a movable conveyance member, the method further comprising initiating an alert action upon (a) detecting the presence of the leading edge of the glass sheet or (b) detecting the presence of the carrier while noting a status of the pair of guide arms as closed.

Another aspect of the present disclosure provides a control system for a glass sheet processing apparatus comprising a gripping device. In certain embodiments, the control system includes a proximity sensor adapted to detect proximity of a carrier with respect to a reference point, the glass sheet being transported by the carrier, a first photoelectronic or ultrasonic sensor in communication with a controller configured to determine a speed of the glass sheet and a distance of the glass sheet with respect to the reference point, a second photoelectronic or ultrasonic sensor in communication with the controller configured to determine a speed of the gripping device and a distance of the gripping device with respect to the reference point, a sensor configured to determine a status of a threading tool, the threading tool including a first upper guide arm and a second upper guide arm, one or more of the first upper guide arm or the second upper guide arm movable between an open position in which the first upper guide arm and the second upper guide arm are separated by a separation distance S greater than a thickness of the glass sheet and a closed position in which the first upper guide arm and second upper guide arm each guide a respective major surface of the glass sheet near a top edge portion of the glass sheet, the controller in communication with the proximity sensor, the first photoelectronic or ultrasonic sensor, the second photoelectronic or ultrasonic sensor, and in further communication with the sensor configured to determine a status of the threading tool. The controller is configured to signal one or more of the first upper guide arm or the second upper guide arm to move between the open position and the closed position based on: (i) a determined proximity of the carrier, (ii) a determined speed of the glass sheet and the distance of the glass sheet with respect to the reference point, and (iii) a determined speed of the one or more gripping devices and the distance of the one or more gripping devices with respect to the reference point, wherein the control system (a) places the threading tool in the closed position after a leading edge of the glass sheet passes the threading tool from an upstream location, (b) places the threading tool in the open position when the gripping device approaches the threading tool from the upstream location and (c) places the threading tool in the closed position after the gripping device passes the threading tool.

### BRIEF DESCRIPTION OF THE DRAWINGS

These and other features, aspects, and advantages of the present disclosure can be further understood when read with reference to the accompanying drawings:

FIG. 1 is a schematic view of a glass processing apparatus including a fusion down-draw apparatus to draw a glass ribbon according to one exemplary embodiment of the disclosure;

FIG. 2 is a schematic perspective view of a washing station of a glass processing apparatus according to one exemplary embodiment of the disclosure;

FIG. 3 depicts an automatic edge guiding tool, and control system, according to one exemplary embodiment of the disclosure;

FIG. 4 and FIG. 5 depict a threading tool according to one exemplary embodiment of the disclosure;

FIG. 6 depicts a control system for a threading tool according to one exemplary embodiment of the disclosure;

FIG. 7 is a schematic depicting the location of a threading tool according to one exemplary embodiment of the disclosure; and

FIGS. 8-12 schematically depict sequential operation of the threading tool according to one exemplary embodiment of the disclosure.

### DETAILED DESCRIPTION

Apparatus and methods will now be described more fully hereinafter with reference to the accompanying drawings in which exemplary embodiments of the disclosure are shown. Whenever possible, the same reference numerals are used throughout the drawings to refer to the same or like parts. However, this disclosure may be embodied in many different forms and should not be construed as limited to the embodiments set forth herein.

It is to be understood that specific embodiments disclosed herein are intended to be exemplary and therefore non-limiting. As such, the present disclosure relates to methods and apparatus for processing a glass sheet. In some embodiments, the glass sheet to be processed can be formed by a glass manufacturing apparatus, can be provided as a glass sheet separated from a glass ribbon, can be provided as a glass sheet separated from another glass sheet, can be provided as a glass sheet obtained from a stack of glass sheets, or can be provided as a freestanding glass sheet.

Methods and apparatus for processing a glass sheet will now be described by way of exemplary embodiments. Description with respect to an apparatus should be understood to also refer to the underlying process for which the apparatus is employed, and similarly, description with respect to process should also be understood to refer to the apparatus employed in the process.

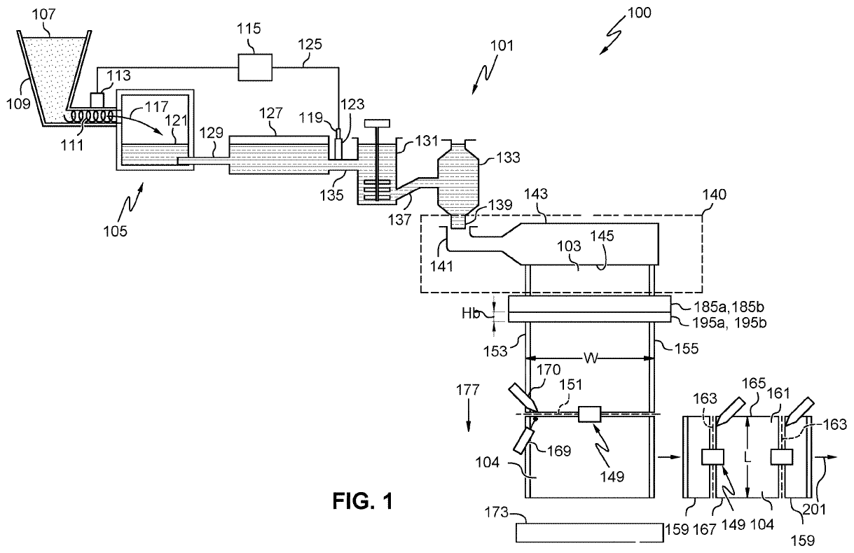

Referring to FIG. 1, embodiments of the present disclosure provide for processing a glass sheet 104 from a glass ribbon 103. As shown, the glass processing system 100 can include multiple exemplary processing stations that may be used individually or in combination with one another. As shown, the processing stations may be arranged in series with one another to process the glass sheet 104. Moreover, it may be desirable to further process the glass sheet 104 (e.g., by a customer further processing the glass sheet 104 for a display application).

Separation debris can include debris associated with the glass separator 149 and produced before, during, or after a separation process with the glass separator 149 under any type of operating conditions of the glass processing system 100. In some embodiments, separation debris can include glass shards and glass chips that are created when the glass ribbon 103 is scored as well as glass shards and glass chips that can break off from the glass ribbon 103 when the glass ribbon 103 is separated with the glass separator 149. Separation debris can also include particles and other contaminants expelled from the glass separator 149 and its related components, such as mechanical dust, lubricants, particulates, fibers, and any other type of debris.

In some embodiments, the glass processing system 100 provides the glass ribbon 103 with a glass manufacturing apparatus 101 such as, but not limited to, a slot draw apparatus, float bath apparatus, down-draw apparatus, up-draw apparatus, press-rolling apparatus, or other glass ribbon manufacturing apparatus. FIG. 1 schematically illustrates the glass manufacturing apparatus 101 including a fusion down-draw apparatus 101 for fusion drawing the glass ribbon 103 for subsequent processing into glass sheets 104.

The fusion down-draw apparatus 101 can include a melting vessel 105 oriented to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. A glass melt probe 119 can be used to measure a level of molten material 121 within a standpipe 123 and communicate the measured information to the controller 115 by way of a communication line 125.

The fusion down-draw apparatus 101 can also include a fining vessel 127 located downstream from the melting vessel 105 and coupled to the melting vessel 105 by way of a first connecting conduit 129. In some embodiments, molten material 121 may be gravity fed from the melting vessel 105 to the fining vessel 127 by way of the first connecting conduit 129. For example, gravity may drive the molten material 121 through an interior pathway of the first connecting conduit 129 from the melting vessel 105 to the fining vessel 127. Within the fining vessel 127, bubbles may be removed from the molten material 121 by various techniques.

The fusion down-draw apparatus 101 can further include a mixing chamber 131 that may be located downstream from the fining vessel 127. The mixing chamber 131 can be used to provide a homogenous composition of molten material 121. As shown, the fining vessel 127 may be coupled to the mixing chamber 131 by way of a second connecting conduit 135. In some embodiments, molten material 121 may be gravity fed from the fining vessel 127 to the mixing chamber 131 by way of the second connecting conduit 135. For example, gravity may drive the molten material 121 through an interior pathway of the second connecting conduit 135 from the fining vessel 127 to the mixing chamber 131.

The fusion down-draw apparatus 101 can further include a delivery vessel 133 that may be located downstream from the mixing chamber 131. The delivery vessel 133 may condition the molten material 121 to be fed into a glass former 140. For example, the delivery vessel 133 can act as an accumulator and/or flow controller to adjust and provide a consistent flow of molten material 121 to the glass former 140. As shown, the mixing chamber 131 may be coupled to the delivery vessel 133 by way of a third connecting conduit 137. In some embodiments, molten material 121 may be gravity fed from the mixing chamber 131 to the delivery vessel 133 by way of the third connecting conduit 137. For example, gravity may drive the molten material 121 through an interior pathway of the third connecting conduit 137 from the mixing chamber 131 to the delivery vessel 133.

As further illustrated, a delivery pipe 139 can be positioned to deliver molten material 121 to the glass former 140 of the fusion down-draw apparatus 101. As discussed more fully below, the glass former 140 may draw the molten material 121 into the glass ribbon 103 from a bottom edge (root) 145 of a forming vessel 143. In the illustrated embodiment, the forming vessel 143 can include an inlet 141 oriented to receive molten material 121 from the delivery pipe 139 of the delivery vessel 133.

In some embodiments, the width “W” of the glass ribbon 103 and a glass sheet 104 can be from about 20 millimeters (mm) to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

In some embodiments, the height “H”, not shown, of the glass sheet 104 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 2500 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

In some embodiments, the thickness “T”, not shown, of a glass sheet 104 made from glass ribbon 103 can be in a range of from about 0.01 mm to about 10 mm, such as from about 0.01 mm to about 9 mm, such as from about 0.01 mm to about 8 mm, such as from about 0.01 mm to about 7 mm, such as from about 0.01 to about 6 mm, such as from about 0.01 mm to about 5 mm, such as from about 0.01 mm to about 4 mm, such as from about 0.05 mm to about 3 mm, such as from about 0.05 mm to about 2 mm, such as from about 0.05 mm to about 1.8 mm, such as from about 0.05 mm to about 1.3 mm, such as from about 0.05 mm to about 1.1 mm, such as from about 0.05 mm to about 0.9 mm, such as from about 0.05 mm to about 0.7 mm, such as from about 0.05 mm to about 0.5 mm, such as from about 0.05 mm to about 0.3 mm and all ranges and subranges therebetween.

The glass ribbon 103 can include a variety of compositions including but not limited to soda-lime glass, borosilicate glass, alumino-borosilicate glass, an alkali-containing glass, or an alkali-free glass. Once exiting the glass former 140, the glass ribbon 103 can then be separated into one or more glass sheets 104 by a glass separator 149. As shown, the glass separator 149 can be positioned downstream from the glass former 140 and oriented to separate the glass sheet 104 from the glass ribbon 103. A variety of glass separators 149 may be provided in embodiments of the present disclosure. For example, a machine may be provided that can mechanically score and then break the glass ribbon 103 along the score line. In some embodiments, a laser-assisted separation device may be provided as described below and in co-pending U.S. Patent Application Publication No. 20160136846, the entirety of which is incorporated herein by reference.

FIG. 1 illustrates a general schematic of an exemplary glass separator 149. As illustrated, an exemplary glass separator 149 may separate the glass sheet 104 from the glass ribbon 103 along the transverse separation path 151 that extends along the width “W” of the glass ribbon 103, transverse to the draw direction 177 of the glass former 140, between a first vertical edge 153 of the glass ribbon 103 and a second vertical edge 155 of the glass ribbon 103.

In some embodiments, the glass separator 149, or another separation device (not shown) can separate an outer portion 159 of the glass sheet 104 from a central portion 161 of the glass sheet 104 along a vertical separation path 163 that extends along a length “L” between a first transverse edge 165 of the glass sheet 104 and a second transverse edge 167 of the glass sheet 104. As illustrated, such a technique can be carried out in a vertical orientation, although horizontal orientations may be provided in some embodiments. In some embodiments, a vertical orientation may facilitate the carrying away of glass particles by gravity.

In some embodiments, a defect (not shown) may be created by mechanically engaging the glass ribbon 103 with, for example, a scribe 170 (e.g., score wheel, diamond tip, etc.) or other mechanical device. In some embodiments, the defect may be created with a laser 169.

In some embodiments, a first elongated gas port 185a and a second elongated gas port 185b may be positioned adjacent the glass former 140, such as near where the glass ribbon 103 exits the glass former 140. The first elongated gas port 185a and the second elongated gas port 185b can be oriented to respectively distribute a first outer curtain of gas and a second outer curtain of gas. The glass processing system 100 can include a vacuum port 173 (e.g., an elongated vacuum port) positioned downstream (e.g., along the draw direction 177, shown in FIG. 1) from the glass separator 149 and oriented to receive debris entrained in the outer curtain of gas. In some embodiments, a baffle (e.g., first baffle 195a, second baffle 195b) may be provided to avoid interference between the first outer curtain of gas and the second outer curtain of gas with a cooling stream being drawn into the lower opening of the glass former 140. In some embodiments, the first baffle 195a and/or the second baffle 195b can be adjustable such that the height “Hb” of each of the first baffle 195a and the second baffle 195b can be selectively adjusted.

As indicated by arrow 201, the glass sheet 104 exits glass processing system 100 to the next processing station in the system. The next downstream processing station can include one or more apparatus for further processing of the glass sheet, which can include, for example, a cleaning station, a drying station, a coating station, a measurement station, or an inspection station.

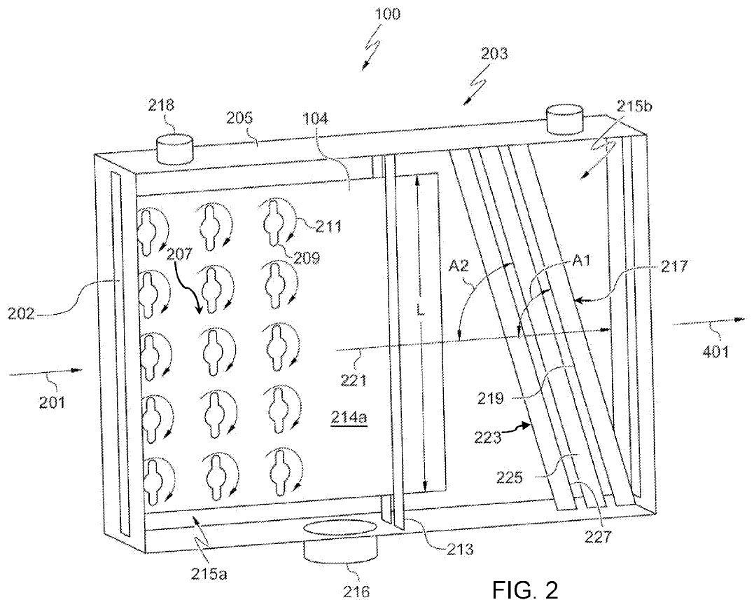

For example, in specific embodiments, the glass sheet can be further processed through a washer 203 used to remove glass chips and/or particles from the glass sheet, such as a high-pressure water washing system having a narrow passageway between nozzles of the washing system. An exemplary embodiment of a washer 203 is shown in FIG. 2, including an entrance opening 202 that may be relatively narrow, for example having a width of less than about 100 mm, for example about 20 mm. If these narrow widths are not maintained, the glass sheet may contact the entrance opening, causing scratches or other damage to the glass sheet 104. Other downstream processing stations such as a drying station, a coating station, an inspection station or a measurement station may also have narrow openings through which the glass sheet passes through.

In some embodiments, the glass sheet 104 can be quickly moved between the separation station (e.g., the glass separator 149) and the washing station (e.g., the washer 203). As discussed above, moving the glass sheet 104 relatively quickly from the glass separator 149 to be received by the washer 203 can help prevent debris (e.g., glass shards, particles, etc.) from adhering to a pristine major surface of the glass sheet 104. Indeed, debris landing on a major surface of the glass sheet 104 during the separation steps can be quickly removed before the debris has time to form a significant bond with the major surface of the glass sheet 104. In some embodiments, relatively quick movement of the glass sheet 104 (represented by travel direction 221 in FIG. 2) can involve a time lapse of from about 1 second to about 20 seconds, such as from about 1 second to about 15 seconds, from the time a trailing edge of glass sheet 104 leaves the separation station until a leading edge of the glass sheet 104 begins being received by the washer 203.

The washer 203 can include a housing 205 with a first liquid dispenser 207 (e.g., a plurality of first liquid dispensers 207) including a first liquid nozzle 209 (e.g., a plurality of first liquid nozzles 209) oriented to dispense liquid against first major surface 214a and second major surface (not shown) of the glass sheet 104 to remove glass particles adhered to first major surface 214a and/or second major surface (not shown) of the glass sheet 104. While not shown, an exemplary washer 203 can dispense liquid against both the first major surface 214a of the glass sheet 104 and the second major surface (not shown) of the glass sheet 104. Accordingly, the depiction of single-sided dispensing, unless otherwise noted, should not limit the scope of the claims appended herewith as such a depiction was conducted for purposes of visual clarity. As shown, the first liquid nozzles 209 can optionally rotate about a rotational axis as indicated by rotational arrows 211. In some embodiments (not shown), the first liquid nozzles 209 can be fixed and non-rotating. Suitable nozzles can include any one or more cone nozzles, flat nozzles, solid stream nozzles, hollow cone nozzles, fine spray nozzles, oval nozzles, square nozzles, etc. In some embodiments, the nozzles can include a flow rate from about 0.25 to about 2500 gallons per minute (gpm) (from about 0.946 to about 9,462.5 liters/min) that operate with pressures of from about 0 psi to about 4000 psi (from about 0 Pa to about 27,579 kPa). Other nozzle types and designs, including nozzles not explicitly disclosed herein, may be provided in some embodiments.

In some embodiments, the housing 205 can be substantially enclosed, although a side wall of FIG. 2 has been removed to reveal features in the interior of the housing 205. Alternatively, the washer 203 can instead be unenclosed, but it will be appreciated that there will generally remain a narrow channel (e.g., from about 1 mm to about 10 mm, from about 1 mm to about 9 mm, from about 1 mm to about 8 mm, from about 1 mm to about 7 mm, from about 1 mm to about 6 mm or from about 1 mm to about 5 mm), for example, around a gas knife 217, for which the glass sheet traverses without the gas knife 217 or other washer components contacting the quality area of the glass, regardless of whether the washer (including dryer) is enclosed or unenclosed. The quality area of the glass, in certain embodiments, refers to the major surfaces of the glass sheet excluding a 5 mm, 10 mm, 15 mm, 20 mm, 25 mm, 50 mm, or 100 mm border around at least the top edge of the glass sheet, depending on the size and intended use of the glass sheet. A skilled artisan will appreciate that the quality/non-quality area of the glass sheet will vary and can be determined based on the specific application.

In some embodiments, the housing 205 can include a partition 213 dividing an interior of the housing 205 into a first area 215a and a second area 215b. The second area 215b can be positioned downstream (e.g., along travel direction 221) from the first area 215a. In the illustrated embodiment, the first area 215a can include the first liquid dispenser 207. A drain 216 can be provided, for example at a bottom of housing 205, to remove the liquid with any debris entrained therein from the process of washing within the first area 215a. A vent 218 can also be provided to prevent pressure build up and to allow vapor and/or gas to escape from the first area 215a of the housing 205. As shown, exemplary embodiments can process a glass sheet 104 in a vertical orientation. Suitable mechanisms used for such vertical orientation and movement thereof are described in W02016064950 Al.

The washer 203 further includes gas knife 217 positioned downstream (e.g., along travel direction 221) from the first liquid dispenser 207, such as within the second area 215b of the housing 205, as shown. The gas knife 217 can include a gas nozzle 219 (e.g., an elongated nozzle) oriented to extend along the entire length “L” of the glass sheet 104 and oriented to dispense gas against the first major surface 214a and the second major surface (not shown) of the glass sheet 104 to remove liquid from the first major surface 214a and the second major surface (not shown) of the glass sheet 104. The gas knife 217 may be oriented at a first angle “A1” relative to the travel direction 221 of the glass sheet 104 through the washer 203. The gas knife 217 can be designed to dispense gas against the first major surface 214a and the second major surface (not shown) of the glass sheet 104 to remove liquid from the first major surface 214a and the second major surface (not shown) of the glass sheet 104. Suitable gases include, but are not limited to, air, nitrogen, low humidity gases, and the like.

As further illustrated, the second area 215b can optionally include a second liquid dispenser 223 including a second liquid nozzle 227 oriented to rinse the first major surface 214a and the second major surface (not shown) of the glass sheet 104 at a location upstream (e.g., along travel direction 221) from the gas knife 217. In some embodiments, the second liquid dispenser 223 can include a lower pressure liquid stream when compared to the pressure of the liquid stream generated by the first liquid dispenser 207 in the first area 215a. Indeed, the lower pressure liquid stream of the second liquid dispenser 223 can wash the first major surface 214a and the second major surface (not shown) of the glass sheet 104 to remove detergents, chemicals, debris, or other impurities remaining on the glass sheet 104. As shown, in some embodiments, a deflector 225 can be positioned downstream (e.g., along travel direction 221) from the second liquid dispenser 223 and upstream from the gas knife 217. The deflector 225 can be oriented to direct an amount of liquid from the second liquid dispenser 223 away from the gas knife 217. As shown, the deflector 225, such as a wiper blade, may be oriented at a second angle “A2” relative to the travel direction 221 of the glass sheet 104 through the washer 203. Moreover, as shown, the second liquid dispenser 223 may likewise optionally include a second liquid nozzle 227 (e.g., an elongated liquid nozzle) oriented at a similar or identical angle of the deflector 225 and the gas knife 217 relative to the travel direction 221 of the glass sheet 104 through the washer 203. The deflector 225 can direct liquid from the second liquid dispenser 223 downward and away from the gas knife 217, thereby reducing the amount of liquid that the gas knife 217 is required to remove from the glass sheet 104.

Although features of FIG. 2 are illustrated acting on a single one of the first major surface 214a and the second major surface (not shown) of the glass sheet 104, it will be appreciated that similar or identical features may be provided on both sides of the glass sheet 104 to thoroughly wash both the first major surface 214a of the glass sheet 104 and the second major surface (not shown) of the glass sheet 104. Accordingly, the left side perspective view of the washer 203 can be a mirror image of the right-side perspective view of the washer 203 illustrated in FIG. 2 and the above discussion and the depiction in FIG. 2 were made for purposes of visual clarity.

Although not shown, the glass sheet 104 may then be dried, for example, with a second gas knife operation or other drying procedure. As indicated by arrow 401 in FIG. 2, the clean and dry glass sheet 104 exiting the washer 203 may then be coated by a coating chamber (not shown) or inspected in an inspection apparatus (not shown) or measured in a measurement apparatus (not shown). An inspection apparatus may inspect one or more attributes of the glass sheet 104 to ensure quality and to determine whether the glass sheet 104 meets one or more requirements that may be set by a customer. The inspection apparatus can be designed to sense one or more of bubbles, inclusions, surface particles, thickness and variations of thickness, squareness, dimensions, edge quality, scratches, cracks, surface imperfections, lines (strings) of distortion, surface shape, surface characteristics or other attributes of the glass sheet 104.

If the glass sheet 104 meets the inspection requirements, the clean glass sheet 104 may be packaged together with other glass sheets 104. In some embodiments, the glass sheets 104 may be placed in a stack with high quality interleaf paper or other material (e.g., polymeric material) disposed between adjacent glass sheets 104. The high-quality interleaf paper or other material can be selected to avoid any contamination of the glass sheet 104 with chemicals or fibers.

In addition to the need to traverse narrow channels (e.g., from about 1 mm to about 100 mm, from about 1 mm to about 50 mm, from about 1 mm to about 25 mm, from about 1 mm to about 10 mm, from about 1 mm to about 9 mm, from about 1 mm to about 8 mm, from about 1 mm to about 7 mm, from about 1 mm to about 6 mm or from about 1 mm to about 5 mm), such as opening 202, in typical drying operations, such as those involving the use of gas knives, the glass sheet cannot vibrate to an unacceptable extent when subjected to the fluid (e.g., high pressure fluid) supplied by the gas knife, all while maintaining proper alignment along the intended motion path from the upstream to the downstream process location. This intended motion path, in certain embodiments, positions the glass sheet such that equal drying force is applied to each major surface, such as by placing each major surface equidistant from its respective air knife. Furthermore, no object or portion of the processing station should contact the glass in the quality area throughout manufacture.

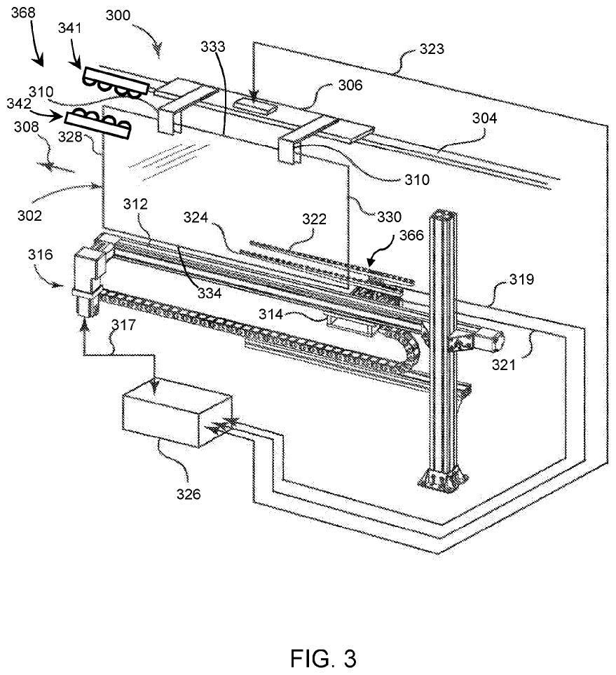

FIG. 3 depicts a transport assembly 300. For example, the glass sheet 302 can be in route to a washer, such as washer 203 in FIG. 2, or the glass sheet 302 may be shown here in FIG. 3 having recently undergone a washing operation and is moving in the direction 308 of a drying operation, such as a drying operation involving a gas knife, or the glass sheet may be moving from a draw process station to an inspection process station, or any other process station that may be employed in a glass manufacturing process.

In this embodiment, transport assembly 300 includes a rail or track 304, for example, an overhead rail system, and a movable mounting assembly 306, wherein movable mounting assembly 306 is designed to travel along rail 304 in a conveyance direction 308. Mounting assembly 306 comprises clamping devices 310 that attach by clamping to glass sheet 302 wherein transport assembly 300 can transport glass sheet 302 to a downstream destination, for example a downstream glass processing station such as washer 203. These clamping devices form a gripping device on the glass sheet along top edge portion 333.

Mounting assembly 306 can be driven by any suitable means, including linear motors, chain or pulley drives and so forth. Mounting assembly 306 can be controlled by a controller 326. Mounting assembly 306 may be moved at a constant speed, or mounting assembly 306 may be moved at a variable speed. In some embodiments it will be necessary to slow or stop mounting assembly 306, and therefore the glass sheet being transported, so that processing of the glass sheet 302 at a given downstream process station may be accomplished, such as during a washing or drying operation.

Transport assembly 300 further comprises a conveyance member 312 including a carriage assembly 314 movable along a length of conveyance member 312 in conveyance direction 308. For example, carriage assembly 314 can be coupled to a drive assembly 316, for example a linear motor, a servo motor or any other drive device suitable to convey carriage assembly 314 along a length of conveyance member 312 in the conveyance direction 308 and in a return direction opposite the conveyance direction 308. Conveyance member 312 can comprise, for example, a track, a rail or any other suitable guidance mechanism capable of supporting and guiding movement of carriage assembly 314 in the conveyance and return directions.

Shown schematically in FIG.3, the top edge portion 333 of the glass sheet approaches a first upper guide arm 341 and a second upper guide arm 342 to form threading tool 368 to provide top edge stability. The glass sheet also approaches first lower guide arm 322 and second lower guide arm 324, which form lower threading tool 366, according to one exemplary embodiment of the disclosure. Solely for purposes of clarity, only the structure of lower threading tool 366 is shown in FIG. 3.

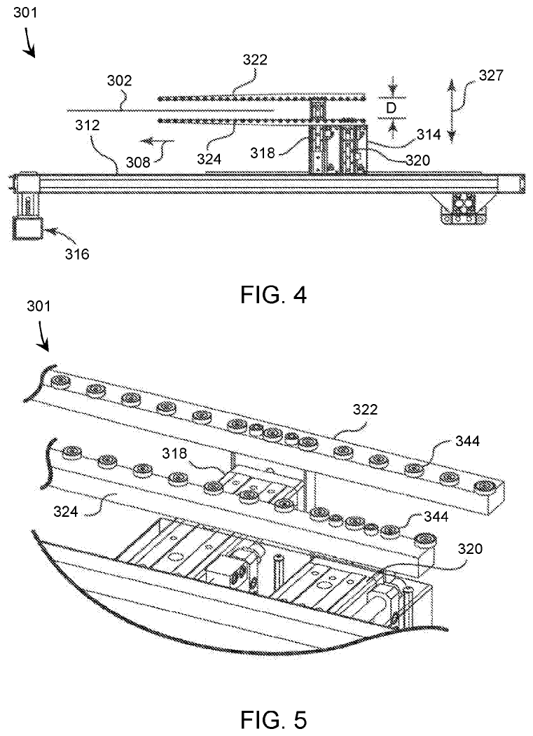

FIGS. 4 and 5 depict a threading tool 301 according to an embodiment, which can provide the structure for threading tool 368 and/or lower threading tool 366, discussed above. This threading tool 301, operated in accordance with the control system described below, can be positioned such that, when in the closed position, it guides a glass sheet, for example, by contacting or engaging the non-quality area along an edge, such as, for example, within 15 mm from the top edge portion 333 of glass sheet 302 in FIG. 3, which is obstructed with one or more gripping devices 310. Threading tool 301, in certain embodiments, can also be positioned such that, when in the closed position, it guides the glass sheet along an opposite edge, such as bottom edge portion 334 in FIG. 3. Merely for convenience, threading tool 301 is described immediately below in the context of it being placed along the bottom edge of the glass sheet.

The threading tool 301 according to this embodiment includes a carriage assembly 314. The carriage assembly 314 includes a first lower extension device 318 and second lower extension device 320, each coupled to the carriage assembly 314. The first lower guide arm 322 and the second lower guide arm 324, respectively, extend from the first lower extension device 318 and second lower extension device 320 and are arranged in an opposing relationship with the each other in a direction substantially parallel with conveyance direction 308. In some embodiments, first lower extension device 318 and second lower extension device 320 can comprise pneumatic slides that respectively extend or retract first lower guide arm 322 and second lower guide arm 324 along lateral direction (shown as arrow 327) orthogonal to conveyance direction 308, i.e., either toward or away from conveyance member 312. In other embodiments, the first lower extension device 318, and the second lower extension device 320 can comprise hydraulic slides or can comprise a servo motor to extend the first lower guide arm 322 and second lower guide arm 324, respectively.

In further embodiments, first lower extension device 318, and second lower extension device 320 can comprise servo motors. In the embodiment depicted in FIGS. 4 and 5, first lower extension device 318 is positioned such that when the first lower extension device 318 extends, first lower guide arm 322 (which is the “outside” guide arm in the Figures) is moved away from conveyance member 312, and when first lower extension device 318 retracts, first lower guide arm 322 moves toward conveyance member 312. Similarly, second lower extension device 320 is positioned such that when the second lower extension device 320 extends, second lower guide arm 324 (which is the “inside” guide arm in the Figures closest to conveyance member 312) is moved away from conveyance member 312, and when second lower extension device 320 retracts, second lower guide arm 324 moves toward conveyance member 312. First and second lower extension devices 318, 320 can be used in opposition to each other such that when one extension device extends, the other extension device retracts, therefore causing first lower guide arm 322 and second lower guide arm 324 to perform an opening or closing operation. For example, if first lower extension device 318 extends and second lower extension device 320 retracts, first lower guide arm 322, and second lower guide arm 324 will perform an opening operation and a separation distance D between the first lower guide arm 322, and the second lower guide arm 324 will increase. Conversely, if first lower extension device 318 retracts and second lower extension device 320 extends, the first lower guide arm 322, and the second lower guide arm 324 will perform a closing operation and the separation D will decrease.

The conveyance member of this embodiment further includes a controller 326 that controls and coordinates movement of carriage assembly 314 and first lower guide arm 322, and second lower guide arm 324 by controlling drive assembly 316 through first control line 317 and first lower extension device 318, and second lower extension device 320 through control communication lines 319, 321, respectively. Controller 326 can further control the movement of mounting assembly 306, for example through second control line 323, although in further embodiments, mounting assembly 306 may be controlled by a second separate controller.

Not shown in FIG. 3 for the sake of simplicity, it is understood that threading tool 368 represented schematically therein by first upper guide arm 341 and second upper guide arm 342, can be provided with a separate control system. This separate control system adjusts the open and closed positions of the first upper guide arm 341 and the second upper guide arm 342, and hence threading tool 368, to negotiate the gripping devices 310. It is further understood that first upper guide arm 341 and second upper guide arm 342 can be engaged with a first upper extension device (not shown) and a second upper extension device (not shown) in the same manner as described with respect to the first lower guide arm 322 and first lower extension device 318 and second lower guide arm 324 and second lower extension device 320. In other embodiments, the controller 326 can provide control of first upper guide arm 341, second upper guide arm 342, first lower guide arm 322 and second lower guide arm 324.

As used herein, the term “controller” or “processor” can encompass all apparatus, devices, and machines for processing data and optionally operating such machines, and including by way of embodiment a programmable processor, a computer, or multiple processors or computers.

The processor can include, in addition to hardware, code that creates an execution environment for the computer program in question, e.g., code that constitutes processor firmware, a protocol stack, a database management system, an operating system, or a combination of one or more of these.

Embodiments and the functional operations described herein can be implemented in digital electronic circuitry, or in computer software, firmware, or hardware, including the structures disclosed in this specification and their structural equivalents, or in combinations of one or more of them. Embodiments described herein can incorporate one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage sheet, a memory device, or a combination of one or more of these.

A computer program (also known as a program, software, software application, script, or code) can be written in any form of programming language, including compiled or interpreted languages, or declarative or procedural languages, and a computer program can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed using one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of example, both general and special purpose microprocessors, and any one or more processors of any kind of digital computer. Generally, a processor will receive instructions and data from a read only memory or a random-access memory or both.

The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of data memory including nonvolatile memory, media and memory devices, including by way of embodiment semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer having a display device, e.g., an LCD (liquid crystal display) monitor, and the like for displaying information to the user, and a keyboard and a pointing device, e.g., a mouse or a trackball, or a touch screen by which the user can provide input to the computer. Other devices can be used to provide for interaction with a user as well; for example, input from the user can be received in any form, including acoustic, speech, or tactile input.

Embodiments described herein can include a computing system that includes a back end component, e.g., as a data server, or that includes a middleware component, e.g., an application server, or that includes a front end component, e.g., a client computer having a graphical user interface or a Web browser through which a user can interact with an implementation of the subject matter described herein, or any combination of one or more such back end, middleware, or front end components. The components of the system can be interconnected by any form or medium of digital data communication, e.g., a communication network. Embodiments of communication networks include a local area network (“LAN”) and a wide area network (“WAN”), e.g., the Internet.

The computing system can include clients and servers. A client and server are generally remote from each other and typically interact through a communication network. The relationship of client and server arises from computer programs running on the respective computers and having a client-server relationship to each other. Controller 326 can control movement of carriage assembly 314 and first lower extension device 318, and second lower extension device 320 via pre-programmed instructions contained in or on computer readable media and executed by the controller.

In other embodiments, controller 326 may control movement of carriage assembly 314 and first lower extension device 318, and second lower extension device 320 in response to external inputs, for example sensor inputs. In still other embodiments, controller 326 may control movement of carriage assembly 314 and first lower extension device 318, and second lower extension device 320 in response to both preprogrammed instructions and sensor input. For example, the transport assembly 300 described in this particular embodiment can include sensors that detect a position of the glass sheet 302 or a portion thereof, including anyone or all of a leading edge 328 and/or a trailing edge 330 of the glass sheet relative to conveyance direction 308, for example a top portion of the leading edge, a bottom portion of the leading edge, a top portion of the trailing edge and/or a bottom portion of the trailing edge. To that end, the transport assembly 300 can include a first sensor 362a positioned to detect leading edge 328 of glass sheet 302 relative to conveyance direction 308.

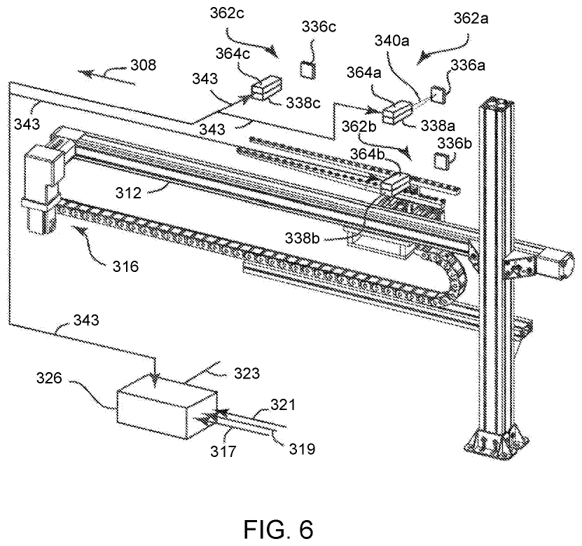

For example, with reference to FIG.6, first sensor 362a may be positioned to detect a leading edge 328 of glass sheet 302 relative to conveyance direction 308. However, or in addition, in further embodiments, first sensor 362a may be positioned to detect a trailing edge 330 of glass sheet 302 relative to conveyance direction 308. First sensor 362a may be a non-contact sensor, for example an optical sensor, although in further embodiments, first sensor 362a may be a contact-style sensor. First sensor 362a may include light source 364a, reflective target 336a and detector 338a. Light source 364a may be, for example, a laser or a focused light emitting diode (LED). First sensor 362a can be positioned upstream of a start position for carriage assembly 314 wherein light source 364a and detector 338a are positioned on one side of the conveyance path, and reflective target 336a is positioned on the opposite side of the conveyance path. Light beam 340a from light source 364a, for example a laser beam, is projected across the conveyance path of glass sheet 302 and reflected by reflective target 336a. The reflected light is then received by detector 338a, wherein the presence or absence of the glass sheet, e.g., leading edge 328, is communicated to controller 326 via an appropriate signal over data line 343. The presence of the glass sheet as detected by detector 338a causes controller 326 to begin the guiding cycle.

Each lower guide arm 322, 324 (and first upper guide arm 341 and second upper guide arm 342) is positioned to restrain movement of a nominally vertical glass sheet positioned between the guide arms. For example, in some embodiments, each guide arm can comprise a plurality of rollers 344 (see FIG. 5) arrayed and rotatably mounted along a length of the each guide arm such that when the guide arms are moved in opposite directions along lateral direction 327 so that the separation distance D between the guide arms is reduced, glass sheet 302 is guided by the rollers, for example, the glass sheet may contact the rollers, which in some embodiments have a roller hardness that is less than the hardness of the glass sheet being processed. For example, depending on the separation distance D between the opposing guide members, glass sheet 302 can contact the rollers sporadically, when lateral movement of the glass sheet is sufficiently great, thereby limiting movement of the glass sheet top edge portion, and/or bottom edge portion, allowing the edge to be maintained within the separation distance D defined by the guide arms. In other embodiments, for example, first upper guide arm 341 and second upper guide arm 342, (and/or first lower guide arm 322 and second lower guide arm 324) can be positioned such that they contact the top edge portion (and/or the bottom edge portion) of the glass sheet during the time glass sheet 302 is positioned between first upper guide arm 341 and second upper guide arm 342 (and/or between the first lower guide arm 322 and the second lower guide arm 324) and thus the rollers (e.g., rollers 344) are in continuous contact with the glass sheet.

Methods of operating transport assembly 300 and the guiding cycle will now be described. Referring to FIGS. 3 and 6, in one embodiment, as transport assembly 300 moves glass sheet 302 along rail 304, light source 364a from first sensor 362a is projecting light beam 340a that reflects from reflective target 336a and is received by detector 338a, in response to which detector 338a indicates to controller 326 with a suitable electrical signal that the conveyance path is clear (i.e., there is an absence of a glass sheet in that portion of the conveyance path illuminated by the light source as received by the detector). Carriage assembly 314 is in its initial start position (e.g., to the right end of conveyance member 312), and first lower guide arm 322, and second lower guide arm 324 are in an open position, for example when the separation distance D is greater than 200 mm. As glass sheet 302 continues to move in conveyance direction 308, leading edge 328 of glass sheet 302 intersects light beam 340a, at which point detector 338a fails to receive reflected light from reflective target 336a or receives insufficient light. Accordingly, detector 338a registers the presence of the glass sheet by the absence of light or receiving insufficient light and sends an appropriate signal to controller 326. In response, controller 326 instructs drive assembly 316 to begin moving carriage assembly 314 in conveyance direction 308.

In some embodiments, transport assembly 300 can further comprise a second sensor 362b positioned below first sensor 362a, second sensor 362b comprising similar components as first sensor 362a with similar functions. For example, second sensor 362b can comprise a light source 364b (e.g., a focused LED or a laser), reflective target 336b and detector 338b positioned to receive light from light source 364b reflected from reflective target 336b. Second sensor 362b may be positioned to detect leading edge 328 simultaneously with first sensor 362a. That is, for a rectangular cut glass sheet, and assuming proper alignment of the top edge portion of the glass sheet in gripping devices 310, leading edge 328 should present a vertical line. Consequently, leading edge 328 should “break” the light beams from both the first and second sensors 362a,b simultaneously. If controller 326 receives signals indicating that simultaneous detection of leading edge 328 was not obtained, then a possible cause could be the glass sheet is broken. The controller may then initiate additional actions, including but not limited to stopping or slowing transport assembly 300 so that glass sheet 302 may be removed, or, transport assembly 300 continues conveying glass sheet 302 but controller 326 registers the position of the glass sheet (relative to other glass sheets that may be conveyed) so that a downstream action can be later taken, for example additional inspection by a human operator. If, on the other hand, simultaneous detection of the leading edge is obtained, the transport assembly 300 (e.g., controller 326) can proceed to move the glass sheet in the conveyance direction without additional action as triggered by a defective glass sheet.

Detection of leading edge 328 can be used by controller 326 to begin movement of carriage assembly 314 in conveyance direction 308. In some embodiments, the speed of glass sheet 302 in the conveyance direction may be obtained by controller 326 directly from mounting assembly 306 or from the driving apparatus for mounting assembly 306. For example, mounting assembly 306, or the driving apparatus, may include an encoder for tracking progress of the mounting assembly along rail 304, including a speed of the mounting assembly along the rail 304. However, in other embodiments, transport assembly 300 may include a third sensor 362c positioned downstream from first sensor 362a.

Similar to first and second sensors 362a, 362b, third sensor 362c can include light source 364c (for example a focused LED or a laser), reflective target 336c and detector 338c and may operate in the same manner as first and second sensors 362a, 362b. Controller 326 can calculate the time between the “glass present” signal from first sensor 362a and the “glass present” signal from third sensor 362c and, for a given glass sheet size pre-programmed into the controller, a speed of the glass sheet in the conveyance direction can be calculated. Thus, once controller 326 has calculated the conveyance speed of the glass sheet, controller 326 can match the speed of carriage assembly 314 to the speed of glass sheet 302. Controller 326 can also signal first lower extension device 318, and second lower extension device 320 to begin closing, thereby reducing the separation distance D. It should be noted that the preceding description utilized the passing of leading edge 328 for determining the presence or absence of the glass sheet in the sensor detection path and for calculating a speed of the glass sheet as conveyed by the mounting assembly. However, similar information can be obtained by detecting the trailing edge 330.

As previously noted, first lower guide arm 322, and second lower guide arm 324 may reduce the separation distance D without employing continuous contact with glass sheet 302, thereby forming a lateral movement envelope defined by the separation distance D for the bottom edge portion of the glass sheet between portions of the guide arms. That is, separation distance D may be reduced to a value less than the fully open separation distance D, but large enough so that the bottom edge portion of the glass sheet is allowed some small amount of lateral movement. For example, the separation distance D may be reduced to a range from about 10 mm to about 100 mm, for example in a range from about 20 mm to about 90 mm. As previously described, first lower guide arm 322, and second lower guide arm 324 may comprise rollers 344, the rollers providing a contact surface which glass sheet 302 may contact. Rollers 344 ensure any relative motion between the glass sheet and the guide arms is accommodated by the rollers rolling against the major surfaces of the glass sheet rather than producing a sliding motion between the guide arms and the glass sheet that could mark or damage the surfaces of the glass sheet. However, in other embodiments, the separation distance D may be reduced until first lower guide arm 322, and second lower guide arm 324 are in continuous contact with glass sheet 302, thereby gripping glass sheet between the opposing guide arms. Whether first lower guide arm 322 and second lower guide arm 324 are in continuous contact or intermittent contact may be dictated by the nature of the downstream process.

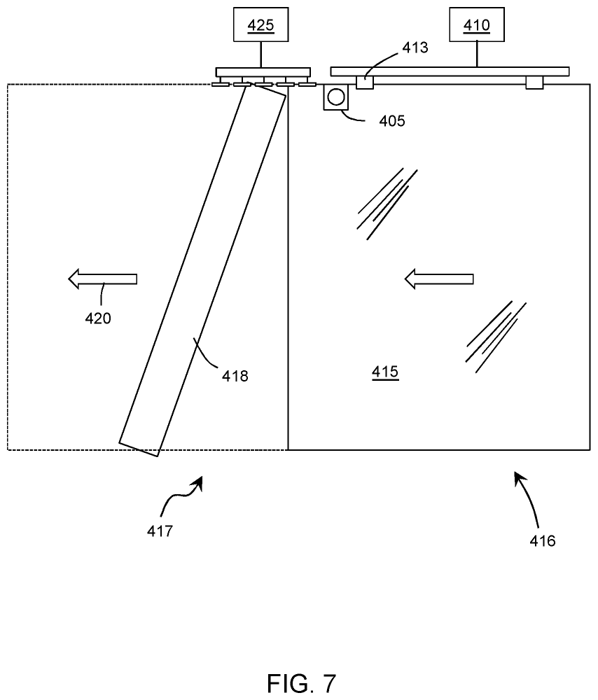

Referring to FIGS. 7-12, sequential operation of a threading tool 425 according to one or more embodiments is shown, in which the threading tool 425 encounters one or more gripping devices 413. In FIGS. 7-12 the threading tool 425 is shown as comprising a first plurality of rollers 430 (e.g., comprising eight rollers with each roller comprising a diameter in a range of from about 15 mm to about 45 mm in diameter and each roller spaced at intervals of from about 30 mm to about 70 mm from an adjacent roller) and a second plurality of rollers 431 (e.g., comprising eight rollers with each roller comprising a diameter in a range of from about 15 mm to about 45 mm in diameter and each roller spaced at intervals of from about 30 mm to about 70 mm from an adjacent roller). The first plurality of rollers 430 and the second plurality of rollers 431 are each respectively mounted to a first upper extension device 435 and a second upper extension device 436 (e.g., a dual rod slide with a 50 mm, or 25 mm or 15 mm stroke available from Nanjing Win Union Automation and Control Technology Co., Ltd. (“SMC”)). When the threading tool 425 is placed in the open position, the first plurality of rollers 430 and second plurality of rollers 431 are separated by a separation distance S.

In this embodiment, separation distance S can be sufficiently large to clear gripping device 413 (including an optional safety tolerance) as gripping device 413 approaches from an upstream process direction. For example, the separation distance S can be greater than about 100 mm, or greater than about 75 mm, or greater than about 50 mm, or greater than about 40 mm, or greater than about 30 mm, or greater than about 27.5 mm, or greater than about 25 mm, or greater than about 20 mm, or greater than about 10 mm, and can be determined by one of ordinary skill based on, among other things, the size of the gripping device and the process environment.

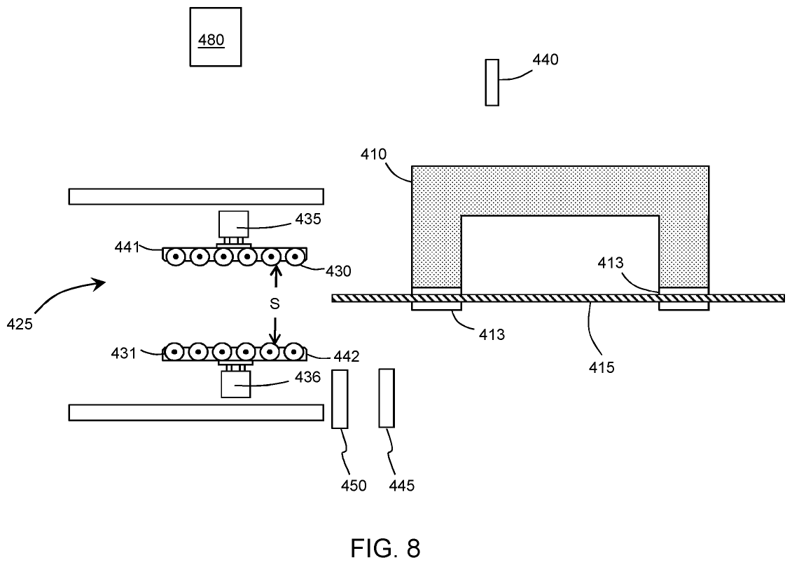

The threading tool 425 further comprises a glass sensor (e.g., a photoelectric sensor available from Keyence Corporation of America) or an ultrasonic sensor (e.g. available from Banner Engineering). The threading tool 425 can further comprise a carrier sensor, such as proximity sensor 440 (e.g., an inductive proximity sensor available from Turck, Inc.) or a capacitance proximity sensor provided to monitor capacitance and hence, monitor the carrier 410 as the carrier conveys a glass sheet 415 through a processing station. In certain embodiments, the carrier can include a metallic component (e.g., the carrier frame can be metallic) and the proximity sensor can be adapted to ascertain a proximity of the metallic component (e.g., the proximity of the metallic frame of the carrier). The threading tool 425 can be arranged as part of a processing station, for example, as shown in FIG. 7, and arranged as schematically shown in FIGS. 8-12.

As shown in FIG. 7, which is a front view, a sensor assembly 405, described in greater detail below, is positioned in proximity to a leading edge of a glass sheet 415. For example, the sensor assembly can be positioned in an apparatus in which the glass sheet 415 has exited a washing subprocess 416, and the glass sheet 415 is about to enter a dryer 417 provided with one or more air knives 418. It will be appreciated that one air knife 418 is shown in FIG. 7, but a second air knife may be positioned on an opposite side of the glass sheet 415 defining a narrow channel (e.g., less than about 100 mm, less than about 50 mm, less than about 25 mm, 10 mm, less than about 9 mm, less than about 8 mm, less than about 7 mm, less than about 6 mm or less than about 5 mm) for the glass sheet 415 to pass through. As the carrier 410, which supports the gripping devices 413, transports the glass sheet 415 from an upstream process direction to a downstream process direction, as indicated by arrow 420, the carrier 410 approaches the threading tool 425.

As shown in FIG. 8, which details the sensor assembly 405 of this embodiment in greater detail, the threading tool 425 comprises a first upper guide arm 441 including the first plurality of rollers 430 mounted on a first upper extension device 435 and spaced apart from a second upper guide arm 442 including the second plurality of rollers 431 mounted on a second upper extension device 436. The first upper extension device 435 and the second upper extension device 436 each can comprise a hydraulic drive, a pneumatic drive or a servo motor drive to extend and retract the first upper extension device 435 and the second upper extension device 436. FIG. 8 shows a carrier sensor, which in this embodiment is a proximity sensor 440 to monitor carrier position, a first photoelectric sensor 445 to detect gripping device 413 and a second photoelectric sensor 450 set to reflective mode to detect a transparent material, such as a glass sheet 415, as separate components. However, it is understood that in some embodiments one or more of these components (e.g., the proximity sensor 440, the first photoelectric sensor 445 and the second photoelectric sensor 450) could be combined to exist as a single sensor assembly. In some embodiments, the first photoelectric sensor 445 and the second photoelectric sensor 450 comprise a single sensor head that can be switched to detect a transparent material such as a sheet of glass or a nontransparent material (e.g. a metallic material or a polymeric material) such as a gripping device.

In various embodiments, a controller 480 can control the operation of the threading tool 425. For example, the controller 480 can send a control signal to place the threading tool 425 in the open position until the carrier sensor (i.e., proximity sensor 440) is triggered. Once the proximity sensor 440 is triggered and sends a signal to the controller 480, the controller 480 initializes the second photoelectric sensor 450 and the controller can determine the rate of movement and/or a travel distance of the incoming glass sheet. As noted above with respect to FIG. 3, a single controller 326 can control operation of the entire transport assembly 300, including the lower guide arms 322, 324 and upper guide arms 441, 442. Thus, in embodiments in which the threading tool 425 shown and discussed with respect to FIGS. 8-12 includes upper and lower guide arms, a single controller or multiple controllers may be used to separately control threading tools that guide upper and lower edges of the glass sheet into a processing station.

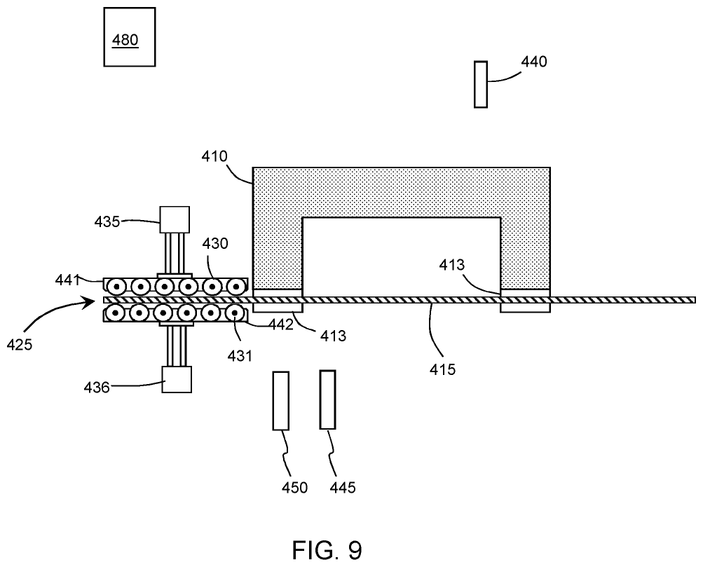

Based on the speed/distance calculation of the incoming glass sheet 415, which has been initialized based on the detected presence of the carrier 410 from the proximity sensor 440, the threading tool 425 will be placed in the closed position once it is determined that the leading edge of the glass has passed, to a pre-determined, acceptable extent, a sufficient distance from the farthest roller to safely close on the leading edge of the glass sheet 415. This is shown in FIG. 9, in which the threading tool 425 is closed to guide the leading edge of the glass sheet as it approaches the air knife 418. In some embodiments, both upper guide arms 441, 442 are moved to reduce the separation distance S. In other embodiments only one of the upper guide arms 441, 442 to reduce the separation distance S. In some embodiments, when the threading tool is in the closed position to guide the leading edge of the glass sheet 415, at least one of the first plurality of rollers 430 or the second plurality of rollers 431 can contact the glass leading edge of the glass sheet. In other embodiments the leading edge of the glass sheet 415 does not contact but is close to the first plurality of rollers 430 and the second plurality of rollers 431. According to one or more embodiments, close refers to less than 0.5 mm, less than 0.4 mm, less than 0.3 mm, less than 0.2 mm or less than 0.1 mm.

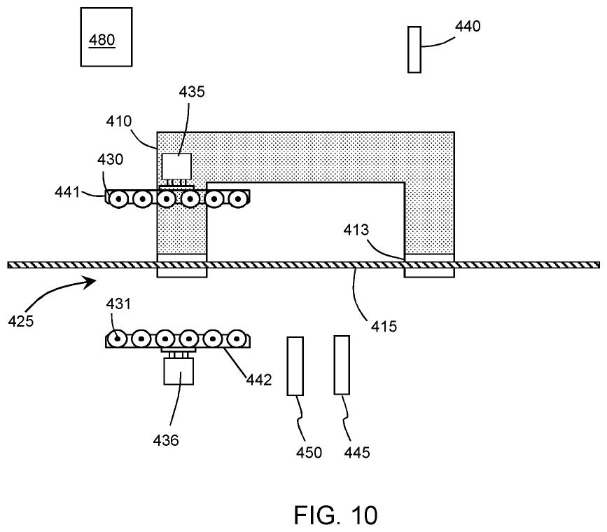

Meanwhile, the first photoelectric sensor 445 detects the position of the gripping devices 413 as they move past the first photoelectric sensor 445. Based on a pre-determined control protocol, the first photoelectric sensor 445 determines when the gripping device 413 is close to the threading tool 425 to register an “active” situation. This active situation, via the controller 480, initiates movement of the first upper extension device 435, and hence first plurality of rollers 430, and the second upper extension device 436, and hence second plurality of rollers 431, to place the threading tool 425 in the open position to allow the gripping devices 413 to pass, as shown in FIG. 10. Once an “active” situation is registered, a separate protocol confirms that the threading tool 425 is in the open position, and if not, an alert action is initiated. For example, the alert action can send an override signal to a conveyor to stop movement of the glass sheet and/or the alert action can sound an audible alarm to prompt operator action.

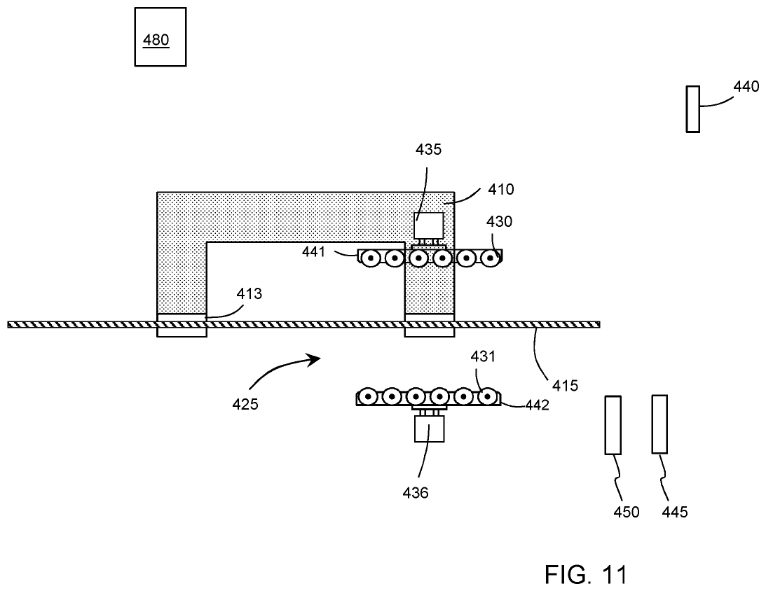

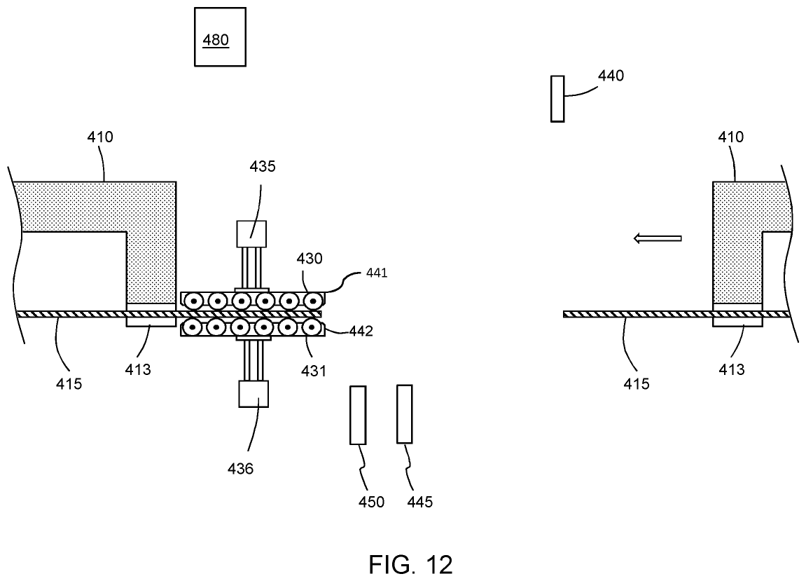

While the threading tool 425 is placed in the open position upon the approach of a first of the gripping devices 413, first photoelectric sensor 445 continues to detect the presence of additional gripping devices 413, and the first upper guide arm 441 and the second upper guide arm 442 remain open until all detected gripping devices 413 have passed. In this embodiment, the glass sheet 415 is provided with two gripping devices, although any number of gripping devices could be provided. FIG. 11 depicts the threading tool 425 in the open position as the second, most-upstream gripping device passes between the first plurality of rollers 430 and second plurality of rollers 431, which are positioned by the controller 480 to be in the open position. Once the gripping device 413 has passed, as shown in FIG. 12, the threading tool 425 is then placed in the closed position to guide the trailing edge of the glass as described above.

At the moment shown in FIG. 12, in which the last gripping device 413 has passed and the threading tool 425 is placed in the closed position, the carrier 410 is stopped and the glass sheet is subjected to an air knife to dry the glass sheet. The threading tool 425 can be placed in the closed position until the trailing edge passes through the air knife 418.

Although the top edge portion of the glass sheet is detailed in the Figures, the bottom edge portion of the glass sheet could also be guided via a lower threading tool (not shown) to add further stability during the drying procedure (for example, using the first lower guide arms 322 and second lower guide arm 324 described herein). As situated as disclosed in FIG. 12, the glass sheet will not vibrate to an unacceptable extent and the glass sheet will maintain a proper motion path to prevent breakage or scratching of the glass sheet.

As discussed above, any contact of the glass sheet with the cleaning or drying equipment will likely result in unacceptable scratches or chips, rendering the glass unusable. This problem is particularly problematic during the processing of thin glass sheets, for example, thin glass sheets that are utilized in display devices. It was determined that glass sheets having a width-by-length dimension of 1550 mm×1810 mm and a thickness of 0.3 mm, glass sheets having a width-by-length dimension of 2500 mm×2200 mm and a thickness of 0.3 mm and glass sheets having width-by-length dimension of 3500 mm×3200 mm and a thickness of 0.5 mm, for example, were particularly difficult to process and convey through a dryer (for example, a dryer as shown in FIG. 7) with one or more air knives 418 blowing a stream of air against a major surface of the glass sheet. In some embodiments, glass sheets have a thickness in a range of from about 0.05 mm to about 2 mm, such as from about 0.05 mm to about 1.8 mm, such as from about 0.05 mm to about 1.3 mm, such as from about 0.05 mm to about 1.1 mm, such as from about 0.05 mm to about 0.9 mm, such as from about 0.05 mm to about 0.7 mm, such as from about 0.05 mm to about 0.5 mm, such as from about 0.05 mm to about 0.3 mm and all ranges and subranges therebetween can be processed through a narrow channel (e.g., a channel only slightly wider than the thickness of the glass, and having a width of less than about 10 mm, less than about 9 mm, less than about 8 mm, less than about 7 mm, less than about 6 mm or less than about 5 mm) of a glass sheet processing station such as a dryer without causing damage to a leading or trailing edge of the thin glass sheet. In some embodiments, a glass sheet having an aspect ratio of length/thickness greater than about 2000, greater than about 3000, greater than about 4000, greater than about 6,000, or greater than about 7,000, can be processed through a processing station according to methods and apparatus described herein, such as a dryer having a narrow channel (e.g., less than about 10 mm, less than about 9 mm, less than about 8 mm, less than about 7 mm, less than about 6 mm or less than about 5 mm), without damaging the leading edge or trailing edge of the glass sheet. Without the threading tool 425 being placed in the closed position to secure the glass sheet, one or more air knives 418 could otherwise cause the sheet to vibrate as the glass sheet passes through a narrow channel in the dryer, causing contact with the dryer, and chipping either one or both of the leading edge 328 of the glass sheet as it enters the dyer or trailing edge 330 of the glass sheet as it exits the dryer. After the drying operation has been completed, the threading tool 425 can then be placed in the open position to allow the trailing edge of the glass sheet to pass without being engaged by the rollers and to await the approach of the next glass sheet 455 in the process.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes embodiments having two or more such light sources unless the context clearly indicates otherwise. Likewise, a “plurality” or an “array” is intended to denote “more than one.” As such, a “plurality” or “array” of outlets includes two or more such elements, such as three or more such outlets, etc.

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it not intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. An apparatus for processing a glass sheet comprising a pair of major surfaces defining a thickness therebetween, the apparatus comprising:
a threading tool comprising a first upper guide arm secured to a first upper extension device, a second upper guide arm secured to a second upper extension device, one or more of the first upper guide arm or the second upper guide arm movable between an open position in which the first upper guide arm and the second upper guide arm are separated by a separation distance S greater than the thickness of the glass sheet and a closed position in which the first upper guide arm and second upper guide arm each guide an opposing major surface of the glass sheet at an edge of the glass sheet;
a gripping device configured to grip a top edge portion of the glass sheet;
a glass sensor positioned to detect a presence of a leading edge of the glass sheet as the glass sheet approaches the glass sensor from an upstream process direction;
a gripping device sensor positioned to detect a presence of the gripping device as the gripping device approaches the gripping device sensor from the upstream process direction; and
a controller configured to coordinate and control movement of one or more of the first upper guide arm or the second upper guide arm between the open position and the closed position based on the detected presence of the glass sheet and the detected presence of the gripping device.

2. The apparatus of claim 1, further comprising a carrier configured to transport the glass sheet.

3. The apparatus of claim 2, further comprising a carrier sensor positioned to detect a presence of the carrier as the carrier approaches the carrier sensor from the upstream process direction.

4. The apparatus of claim 3, wherein the gripping device is supported by the carrier.

5. The apparatus of claim 4, wherein the carrier comprises a metallic component and the carrier sensor comprises a proximity sensor adapted to ascertain a proximity of the metallic component.

6. The apparatus of claim 1, wherein the glass sheet comprises a length, and an aspect ratio defined as the length divided by the thickness is greater than about 2000.

7. The apparatus of claim 1, further comprising a lower threading tool comprising a first lower guide arm secured to a first lower extension device and a second lower guide arm secured to a second lower extension device, one or more of the first lower guide arm or the second lower guide arm movable between an open position in which the first lower guide arm and the second lower guide arm are separated by a separation distance D greater than the thickness of the glass sheet and a closed position in which the first lower guide arm and the second lower guide arm each guide an opposing major surface of the glass sheet at a bottom edge portion of the glass sheet.

8. The apparatus of claim 1, wherein the separation distance S is from about 1.0 mm to about 50 mm.

9. The apparatus of claim 1, wherein the one or more gripping devices are located from about 0.1 mm to about 15 mm below the top edge portion of the glass sheet, and in the closed position, and the first upper guide arm and the second upper guide arm are configured to guide the glass sheet from 0.1 mm to about 15 mm below the top edge portion of the glass sheet.

10. The apparatus of claim 1, wherein one or more of the glass sensor or the gripping device sensor comprises a photoelectric sensor or an ultrasonic sensor.

11. A method of processing a glass sheet comprising a pair of major surfaces defining a thickness therebetween, a leading edge, and a trailing edge, the method comprising:
conveying the glass sheet in a conveyance direction so that the leading edge is conveyed through a glass sheet processing station followed by the trailing edge, the glass sheet supported from a top edge portion of the glass sheet by a gripping device;
detecting a presence of the leading edge of the glass sheet with a glass sensor as the glass sheet moves in the conveyance direction from an upstream location;
closing a pair of guide arms on the glass sheet after the leading edge of the glass sheet has been detected by the glass sensor such that the pair of guide arms each guide the glass sheet;
detecting a presence of the gripping device with a gripping device sensor;
opening the pair of guide arms to allow the gripping device to pass between the pair of guide arms; and
closing the pair of guide arms after the gripping device has been conveyed past the gripping device sensor.

12. The method of claim 11, further comprising drying the glass sheet after the gripping device has been conveyed past the gripping device sensor and the pair of guide arms are closed.

13. The method of claim 12, wherein drying the glass sheet comprises applying a gas to the glass sheet to dry the glass sheet.

14. The method of claim 11, further comprising transporting the glass sheet from the upstream location with a carrier and detecting a presence of the carrier with a carrier sensor.

15. The method of claim 14, wherein the carrier is transported from the upstream location with a movable conveyance member, the method further comprising initiating an alert action upon (a) detecting the presence of the leading edge of the glass sheet or (b) detecting the presence of the carrier while noting a status of the pair of guide arms as closed.

16. A control system for a glass sheet processing apparatus comprising a gripping device, the control system comprising:
a proximity sensor adapted to detect a proximity of a carrier relative to a reference point, the glass sheet being transported by the carrier;
a first photoelectronic or ultrasonic sensor in communication with a controller configured to determine a speed of the glass sheet and a distance of the glass sheet relative to the reference point;
a second photoelectronic or ultrasonic sensor in communication with the controller configured to determine a speed of the gripping device and a distance of the gripping device relative to the reference point;
a sensor configured to determine a status of a threading tool, the threading tool including a first upper guide arm and a second upper guide arm, one or more of the first upper guide arm or the second upper guide arm movable between an open position in which the first upper guide arm and the second upper guide arm are separated by a separation distance S greater than a thickness of the glass sheet and a closed position in which the first upper guide arm and second upper guide arm each guide a respective major surface of the glass sheet near a top edge portion of the glass sheet; and
wherein the controller is in communication with the proximity sensor, the first photoelectronic or ultrasonic sensor, the second photoelectronic or ultrasonic sensor, and in further communication with the sensor configured to determine a status of the threading tool, the controller configured to signal one or more of the first upper guide arm or the second upper guide arm to move between the open position and the closed position based on:
(i) a determined proximity of the carrier;
(ii) a determined speed of the glass sheet and the distance of the glass sheet relative to the reference point; and
(iii) a determined speed of the one or more gripping devices and the distance of the one or more gripping devices relative to the reference point,
wherein the control system (a) places the threading tool in the closed position after a leading edge of the glass sheet passes the threading tool from an upstream location, (b) places the threading tool in the open position when the gripping device approaches the threading tool from the upstream location and (c) places the threading tool in the closed position after the gripping device passes the threading tool.
